(19) United States
(12) Patent Application Publication
(10) Pub. No.: US 2025/0274754 A1
(43) Pub. Date: Aug. 28, 2025

(54) AUTHENTICATION METHOD, TERMINAL, AND NETWORK DEVICE

(71) Applicant: HUAWEI TECHNOLOGIES CO., LTD., Shenzhen (CN)

(72) Inventors: Chitra JAVALI, Singapore (SG); Li SUN, Shenzhen (CN)

(21) Appl. No.: 19/202,032

(22) Filed: May 8, 2025

Related U.S. Application Data
(63) Continuation of application No. PCT/CN2022/131650, filed on Nov. 14, 2022.

(51) Int. Cl. H04W 12/06; H04W 24/08

(52) U.S. Cl. CPC H04W 12/06; H04W 24/08

(57) ABSTRACT

This application provides an authentication method and communication apparatus. The method includes: measuring, by a network device, at least one first signal from a terminal to obtain a first measurement result, where the first measurement result is used for determining the distance between the terminal and the network device; determining, by the network device, that the terminal is not rejected to access network based on the first measurement result; transmitting, by the network device, at least one second signal to the terminal; receiving, by the network device, authentication information from the terminal, where the authentication information is obtained based on a second measurement result of the at least one second signal; and determining, by the network device, whether the terminal is allowed to access network based on the authentication information.

### CROSS-REFERENCE TO RELATED APPLICATIONS

This application is a continuation of International Application No. PCT/CN2022/131650, filed on Nov. 14, 2022, the disclosure of which is hereby incorporated by reference in its entirety.

### TECHNICAL FIELD

This application relates to the wireless communications field, and more specifically, to an authentication method, a terminal, and a network device.

### BACKGROUND

A network device needs to determine whether a terminal is allowed to access network based on distance between the network device and the terminal in many scenarios. For example, a terminal requests access banking network, where the terminal is allowed to access banking network only if the terminal is in the vicinity of the bank. A network device could determine whether a terminal is in a vicinity based on a measurement result, which can be obtained by measuring signals from the terminal. However, this mechanism is not secure because illegal terminals can be allowed to access network by transmitting signals to the network device with high transmitting power. Therefore, the technical problem to be solved is how to improve the security of access network.

### SUMMARY

This application provides an authentication method, a terminal, and a network device, to improve the security of access network.

According to a first aspect, an authentication method is provided, the method can be performed by a network device or a chip in the network device. The method includes: measuring, by a network device, at least one first signal from a terminal to obtain a first measurement result, where the first measurement result is used for determining the distance between the terminal and the network device; determining, by the network device, that the terminal is not rejected to access network based on the first measurement result; transmitting, by the network device, at least one second signal to the terminal; receiving, by the network device, authentication information from the terminal, where the authentication information is obtained based on a second measurement result of the at least one second signal; and determining, by the network device, whether the terminal is allowed to access network based on the authentication information.

In this application, a network device determines whether a terminal is allowed to access network after double verifications. A first verification is based on a first measurement result, which is measured by the network device. If the network device determines that the terminal is not rejected to access network, the network device would perform a second verification based on the authentication information, which is obtained based on a second measurement by the terminal. Thereby, an illegal terminal uses high power to transmit signals to the network device, the network device measures received signals and gets wrong result in the first verification. Since the illegal could not obtain right authentication information, the network device would reject the illegal terminal to access network in the second verification. Thus, the authentication method proposed in this application can improve the security of access network.

In some possible implementations, where the authentication information is obtained by performing a secure sketch processing on the second measurement result, and determining whether the terminal is allowed to access network based on the authentication information includes: a recovery processing is performed successfully on the authentication information based on the first measurement result, the terminal is allowed to access network, where the recovery processing corresponds to the secure sketch processing; or the recovery processing is performed unsuccessfully on the authentication information based on the first measurement result not successfully, so that the terminal is not allowed to access network.

In this application, the network device and the terminal can apply a secure sketch processing and a recovery processing when determine whether a terminal is allowed to access network.

In some possible implementations, the method further includes: receiving, by the network device, request information from the terminal, where the request information requests access network; and transmitting, by the network device, acknowledgement information to the terminal, where the acknowledgement information indicates the terminal transmitting the at least one first signal and measuring the at least one second signal.

In some possible implementations, performing the recovery processing on the authentication information based on the first measurement result includes: performing a quantization processing on the first measurement result, and performing the recovery processing on the authentication information based on the quantized first measurement result.

Optionally, the quantization processing includes at least one of: noise reduction processing and encoding processing.

In this application, the quantization processing may be used to improve the convenience of a recovery processing.

In some possible implementations, the at least one first signal is measured over a period of time, and the at least one second signal is transmitted over the period of time.

Optionally, the period of time is based on a channel rate.

Optionally, the network device determines the period of time and transmits measurement indicate information to the terminal, where the measurement indicate information indicates the period of time.

In this application, a network device and a terminal measure received signals over a period of time, so that the first measurement result and the second measurement result can be used for the secure sketch processing and the recovery processing.

In some possible implementations, the first measurement result comprises signal strength of the at least one first signal, and the second measurement result comprises signal strength of at least one second signal.

Optionally, the first measurement result includes a received signal strength indicator (RSSI) of the first signals and the second measurement result includes an RSSI of the second signals.

According to a second aspect, an information transmission method is provided, the method can be performed by a terminal or a chip in the terminal. The method includes: transmitting, by a terminal, at least one first signal to a network device, where the at least one first signal is used for determining the distance between the terminal and the network device; measuring, by the terminal, at least one second signal from the network device to obtain a second measurement result; obtaining, by the terminal, authentication information based on the second measurement result, where the authentication information is used for determining whether the terminal is allowed to access network; and transmitting, by the terminal, the authentication information to the network device.

In some possible implementations, obtaining the authentication information based on the second measurement result includes: performing, by the terminal, a secure sketch processing on the second measurement result to obtain the authentication information.

In some possible implementations, the method further includes: transmitting, by the terminal, request information to the network device, where the request information requests access network; and receiving, by the terminal, acknowledge information from the network device, where the acknowledgement information indicates the terminal transmitting the at least one first signal and measuring the at least one second signal.

In some possible implementations, performing the secure sketch processing on the second measurement result to obtain the authentication information includes: performing a quantization processing on the second measurement result, and performing the secure sketch processing on the quantized second measurement result to obtain the authentication information.

In some possible implementations, the at least one second signal is measured over a period of time, and the at least one first signal is transmitted over the period of time.

In some possible implementations, the first measurement result comprises signal strength of the at least one first signal, and the second measurement result comprises signal strength of at least one second signal.

Various implementations of the second aspect are terminal methods corresponding to the various implementations of the first aspect. For the beneficial technical effects of the various implementations of the second aspect, reference may be made to the descriptions of the relevant implementations of the first aspect, which will not be repeated here.

According to a third aspect, a network device is provided. The network device includes a function or unit configured to perform the method according to any one of the first aspect or the possible implementations of the first aspect.

According to a fourth aspect, a terminal is provided. The terminal includes a function or unit configured to perform the method according to any one of the second aspect or the possible implementations of the second aspect.

According to a fifth aspect, a system is provided. The system includes: the network device according to the third aspect and the terminal according to the fourth aspect.

According to a sixth aspect, a network device is provided. The network device includes a processor, a memory, and a communications interface. The processor and the memory are connected to the communications interface. The memory is configured to store an instruction, the processor is configured to execute the instruction, and the communications interface is configured to communicate with other network elements under control of the processor. When the processor executes the instruction stored in the memory, the processor is enabled to perform the method according to any one of the first aspect or the possible implementations of the first aspect.

According to a seventh aspect, a terminal is provided. The terminal includes a processor, a memory, and a communications interface. The processor and the memory are connected to the communications interface. The memory is configured to store an instruction, the processor is configured to execute the instruction, and the communications interface is configured to communicate with other network elements under control of the processor. When the processor executes the instruction stored in the memory, the processor is enabled to perform the method according to any one of the second aspect or the possible implementations of the second aspect.

According to an eighth aspect, a computer storage medium is provided. The computer storage medium stores program code, and the program code is used to execute an instruction for the method according to any one of the first aspect or the possible implementations of the first aspect.

According to a ninth aspect, a computer storage medium is provided. The computer storage medium stores program code, and the program code is used to execute an instruction for the method according to any one of the second aspect or the possible implementations of the second aspect.

### BRIEF DESCRIPTION OF DRAWINGS

FIG. 1 is a schematic diagram of an application scenario according to this application;

FIG. 2 is a schematic flowchart of an information transmission method;

FIG. 3 is a schematic diagram of a quantization processing and a secure sketch processing on a terminal side;

FIG. 4 is a schematic diagram of a quantization processing and a recovery processing on a network device side; and

FIG. 5-9 are schematic block diagrams of possible devices according to an embodiment of this application.

### DESCRIPTION OF EMBODIMENTS

The following describes technical solutions of this application with reference to the accompanying drawings.

The technical solutions in embodiments of this application may be applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a future 5th generation (5G) system, or a new radio (NR) system.

A terminal in embodiments of this application may be user equipment, an access terminal, a subscriber unit, a subscriber station, a mobile station, a remote station, a remote terminal, a mobile device, a user terminal, a terminal device, a wireless communication device, a user agent, or a user apparatus. The terminal may alternatively be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal in a future 5G network, a terminal in a future evolved public land mobile communication network (PLMN), or the like. This is not limited in embodiments of this application.

A network device in embodiments of this application may be a device configured to communicate with the terminal. The network device may be a base transceiver station (BTS) in a global system for mobile communications (GSM) or a code division multiple access (CDMA) system, may be a NodeB (NB) in a wideband code division multiple access (WCDMA) system, or may be an evolved NodeB (eNB or eNodeB) in an LTE system, or may be a radio controller in a cloud radio access network (CRAN) scenario. Alternatively, the network device may be a relay station, an access point, a vehicle-mounted device, a wearable device, a network device in a future 5G network, a network device in a future evolved PLMN, or one or a group of antenna panels (including a plurality of antenna panels) of a base station in a 5G system, or may be a network node that constitutes a gNB or a transmission point, for example, a baseband unit (BBU) or a distributed unit (DU). This is not limited in embodiments of this application.

In some deployment, the gNB may include a centralized unit (CU) and the DU. The gNB may further include an active antenna unit (AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a media access control (MAC) layer, and a physical (PHY) layer. The AAU implements some physical layer processing functions, radio frequency processing, and a function related to an active antenna. Information at the RRC layer is eventually converted into information at the PHY layer, or is converted from information at the PHY layer. Therefore, in this architecture, higher layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (AN), or the CU may be classified into a network device in a core network (CN). This is not limited in this application.

In embodiments of this application, the terminal or the network device includes a hardware layer, an operating system layer running above the hardware layer, and an application layer running above the operating system layer. The hardware layer includes hardware such as a central processing unit (CPU), a memory management unit (MMU), and a memory (which is also referred to as a main memory). The operating system may be any one or more computer operating systems that implement service processing through a process, for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not specifically limited in embodiments of this application, provided that a program that records code of the method provided in embodiments of this application can be run to perform communication according to the method provided in embodiments of this application. For example, the execution body of the method provided in embodiments of this application may be the terminal or the network device, or may be a functional module that can invoke a program and execute the program in the terminal or the network device.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, a computer-readable medium may include but is not limited to: a magnetic storage component (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). In addition, various storage media described in this specification may indicate one or more devices and/or other machine-readable media that are configured to store information. The term “machine-readable media” may include but is not limited to a wireless channel, and various other media that can store, include, and/or carry instructions and/or data.

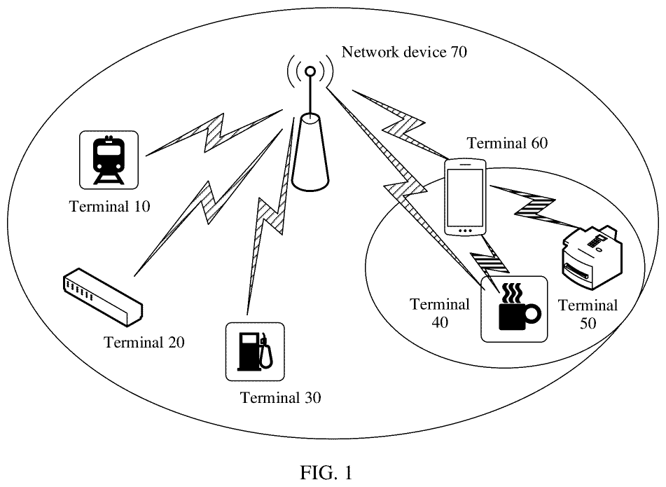

FIG. 1 is a schematic diagram of a communication system according to this application. The communication system in FIG. 1 may include at least one terminal (for example, a terminal 10, a terminal 20, a terminal 30, a terminal 40, a terminal 50, and a terminal 60) and a network device 70. The network device 70 is configured to provide a communication service for the terminal and access a core network. The terminal may access a network by searching for a synchronization signal, a broadcast signal, or the like sent by the network device 70, to communicate with the network. The terminal 10, the terminal 20, the terminal 30, the terminal 40, and the terminal 60 in FIG. 1 may perform uplink and downlink transmission with the network device 70. For example, the network device 70 may send downlink signals to the terminal 10, the terminal 20, the terminal 30, the terminal 40, and the terminal 60, or may receive uplink signals sent by the terminal 10, the terminal 20, the terminal 30, the terminal 40, and the terminal 60.

In addition, the terminal 40, the terminal 50, and the terminal 60 may also be considered as a communication system. The terminal 60 may send downlink signals to the terminal 40 and the terminal 50, or may receive uplink signals sent by the terminal 40 and the terminal 50.

It should be noted that embodiments of this application may be applied to a communication system including one or more network devices, or may be applied to a communication system including one or more terminals. This is not limited in this application.

It should be understood that the communication system may include one or more network devices. One network device may send data or control signaling to one or more terminals. A plurality of network devices may simultaneously send data or control signaling to one or more terminals.

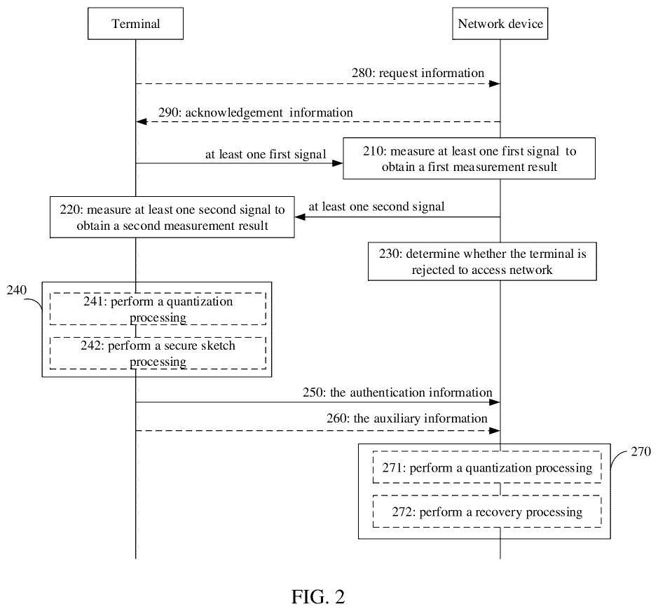

This application provides an authentication method, a terminal and a network device. The terminal transmits at least one first signals to the network device and the network device measures the at least one first signal to obtain a first measurement result. The network device transmits at least one second signals to the terminal and the terminal measures the at least one second signal to obtain a second measurement result. The terminal obtains authentication information based on the second measurement result, and transmits the authentication information to the network device. The network device determines whether the terminal is rejected to access network based on the first measurement result. If the network device determines that the terminal is not rejected to access network, the network device determines whether the terminal is allowed to access network based on the authentication information. Thereby, even if an illegal terminal uses high power to transmit signals to the network device, the network device measures received signals and gets wrong result in the first verification. Since the illegal could not obtain right authentication information, the network device would reject the illegal terminal to access network in the second verification. Thus, the authentication method proposed in this application can improve the security of access network. The following describes the method in detail with reference to FIG. 2-4.

FIG. 2 is a schematic flowchart of an information transmission method according to an embodiment of this application. A network device in FIG. 2 may correspond to the network device 70 in FIG. 1. A terminal in FIG. 2 may correspond to any one of the terminals 10 to 60 in FIG. 1.
210: A terminal transmits at least one first signal to a network device, and correspondingly, the network device measures the at least one first signal to obtain a first measurement result.
220: The network device transmits at least one second signal to the terminal, and correspondingly, the terminal measures the at least one second signal to obtain a second measurement result.

The network device measuring the first signals and the terminal measuring the second signals may be referred as being synchronous.

Optionally, the at least one first signal is measured over a period of time, and the at least one second signal is measured over the period of time, that is, the network device and the terminal exchange a series of signals over a period of time. For example, the network device sends one or more request messages (which are second signals) to the terminal, and the terminal sends one or more corresponding respond messages (which are first signals) to the network device.

It should be noted that, for convenience of description, the period of time is sometimes represented by a symbol T.

Optionally, the period of time T is based on a channel rate, that is, the period of time T may be determined based on the channel rate at which a channel is measured. For example, if the channel rate is higher than or equal to a threshold, T=T1, and if the channel rate is below the threshold, T=T2, and T1<T2.

It should be noted that the period of time T may be preset, or determined by the network device, or determined by the terminal, which is not particularly limited in the application.

Optionally, the first measurement result includes signal strength of the first signals. The second measurement result includes signal strength of the second signals.

For example, the first measurement result includes received signal strength indicator (RSSI) of the first signals and the second measurement result includes RSSI of the second signals. For relevant information about RSSI, reference may be made to existing protocols, which will not be repeated here.

For example, the terminal captures N RSSI samples as X={x1, x2, . . . , xN}, where xi represents an RSSI value of the i-th received signal, and N≥1, i∈[1, N], and the network device captures M RSSI samples as Y={y1, y2, . . . , yM}, where yj represents an RSSI value of the j-th received signal, and M≥1, j∈[1, M].
230: The network device determines whether the terminal is rejected to access network based on the first measurement result.

Whether a terminal is allowed to access network could depend on the distance between the terminal and the network device. A terminal is allowed to access network when the distance between the network and the terminal is in a specific range, and the terminal is rejected to access network when the distance is not in the specific range. Alternatively, a terminal is allowed to access network when the distance is less than or equal to a preset value, and the terminal is rejected to access network when the distance is larger than the preset value. For example, a terminal is allowed to access banking network only if the terminal is in the bank. For another example, a terminal is allowed to share files only if the terminal is in the proximity of the network device.

The first measurement result can be used for determining the distance between the terminal and the network device. For example the signal strength of signals can be used for determining the distance, the higher the signal strength is, and the closer the terminal and the network device are.

Optionally, the network device may perform data processing on the first measurement result, for example, the data processing may include but be not limited to taking an absolute value, taking a mean value, and removing an extreme value.

For example, when a terminal is in a preset region, where the distance d between the terminal and a network device is d1≤d≤d2, where d1 is the minimum distance from the network device in the preset region, and d2 is the maximum distance from the network device in the preset region. A preset range may be set as v1≤v&v2, where v is the mean of the absolute values of the first signal strength values (for example, v=mean (absolute values of (y₁, y₂, . . . , y_{N})), v1 is the minimum signal strength value in the preset range and v2 is the maximum signal strength value in the preset range. If the v is not in the preset range, the network device may determine to reject the terminal to access network.

The above determining processing may refer to a proximity-based access or authentication, which may be considered as one of the authentication mechanisms that requires the location of the terminal, for example, a terminal can be provided access to a service only if the terminal is within or outside the first region. The method can also be applied to multi-factor authentication which forms an additional layer of authentication mechanism. Multi-authentication can improve the security of access network because the multi-factor authentication confirms whether a terminal is legitimately requesting the access network even if any attackers steals credentials.

The first measurement result is used to preliminarily determine whether to reject the terminal, and even if the first measurement result is in the preset range, the network does not determine that the terminal is allowed to access network. For example, an illegal terminal, which is farther away from the network device, uses strong power to transmit signals to the network device, so that the network device would mistakenly determine that the illegal terminal is very close. In embodiments of this application, the network device would not allow the terminal to access network only based on the first measurement result. If the network device determines that the terminal is not rejected to access network based on the first measurement result, the network device would further confirm according to the following authentication information.
240: The terminal obtains authentication information based on the second measurement result.

The authentication information is used for determining whether the terminal is allowed to access network. For example, the terminal performs the following steps 241 and 242 to obtain the authentication information.
Optionally, 241: the terminal performs a quantization processing on the second measurement result.

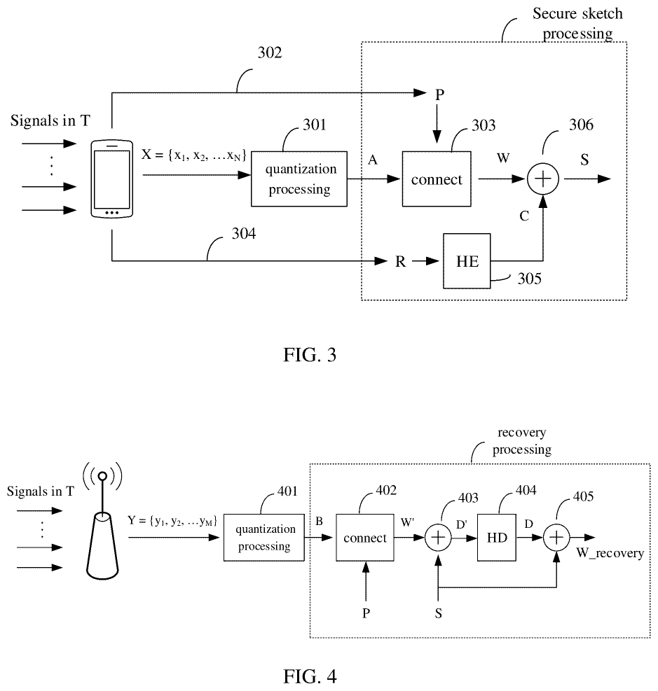

A quantization processing may include noise reduction processing, which may be used to reduce a noise component in the measurement result. Therefore, the quantization processing can be used to improve the accuracy of measurement result. For another example, the quantization processing may also include encoding processing, such as Gray encoding or Binary encoding, which may be used to improve the convenience of information processing and transmission. A more detailed description can be found in FIG. 3, which is not repeated here.
Optionally, 242: the terminal performs a secure sketch processing on the quantized second measurement result, to obtain authentication information.

The authentication information, which is obtained by performing a secure sketch processing on the second measurement result, could be used for verifying the credibility of the first measurement result. The secure sketch processing could verify the correlation of the first measurement result and the second measurement result, if the first measurement result and the second measurement result are related, the first measurement result could be considered credible. In order to facilitate understanding of the embodiments of the present application, the secure sketch processing will be described in more detail below with reference to FIG. 3, and it is not repeated here.
250: the terminal transmits the authentication information to the network device.

Optionally, the authentication information may be carried in an authentication message. For example, the authentication message includes the authentication information and may further include at least one of the following: encryption information, and identity information of the terminal, where the encryption information may be used to encrypt the authentication message and the identity information indicates the terminal.

For example, the authentication information may be carried in a message: Encₖ {ID_{UE}∥S∥Nonce}∥MACₖ{ID_{UE}∥S∥Nonce}, where Encₖ represents encryption, ID_{UE} represents the identity of the terminal, Nonce is a random number which can be a timestamp, MACₖ represents MAC (message authentication code) functions. In addition, the subscription k represents a shared symmetric key between the terminal and the network device, and the symbol ∥ represents a concatenation function in the disclosure, and the following description will not be repeated.

In some implementations, the verifying processing requires not only the authentication information, but also auxiliary information, which is shared by the terminal and the network device. The method may further include 260.
Optionally, 260: the terminal transmits auxiliary information to the network device.

The auxiliary information may be used to assist the network device to perform a recovery processing corresponding to the secure sketch processing. The auxiliary information may be determined according to the secure sketch processing, such as but not limited to the following case, the auxiliary information may be auxiliary data which is called a sketch. A more detailed description can be found in FIG. 3.

It should be noted that, the auxiliary information may be carried in the message carrying the authentication information. Or the auxiliary information may be carried in a separate message, such as Encₖ{ID_{UE}∥P∥Nonce}∥MACₖ{ID_{UE}∥P∥Nonce}, where P represents the auxiliary information. This is not limited in embodiments of this application.
270: The network device determines whether the terminal is allowed to access network based on authentication information.

If the network device determines that the terminal is not rejected to access network based on a first measurement result in the step 230, the network device would further verify the reliability of the first measurement result. For example, the authentication information is obtained by performing a quantization processing (241) and a secure sketch processing (242), the network device could perform steps 271 and 272 to determine whether the terminal is allowed to access network.
Optionally, 271: the network device performs a quantization processing on the first measurement result.

The quantization manner in which the terminal and the network device respectively perform may be similar, a more detailed description can be found in step 240 and FIG. 4.
Optionally, 272: the network device performs a recovery processing on the authentication information.

The network device performs a recovery processing, which corresponds to the secure sketch processing, on the authentication information based on the quantized first measurement result. If the network device performs the recovery processing successfully, so that the terminal is allowed to access network. If the network device does not perform the recovery processing successfully, so that the terminal is rejected to access network device.

It should be noted that the recovery processing can be performed successfully only if the first measurement result and the second measurement result are related. And then if the first measurement result and the second measurement result are related, the network device will determine that the first measurement result is credible and allow the terminal to access network. Therefore, if an illegal terminal uses strong power to transmit signals to the network device and the network device obtains a measurement result, since the network device could not perform a recovery processing on the authentication information based on this measurement result successfully, the network device would reject the terminal to access network.

It also should be noted that whether a recovery processing is successfully performed is based on the algorithm setting of the recovery processing, which is not specifically limited in embodiments of the application. In order to facilitate understanding of the embodiments of the present application, the recovery processing will be described in more detail below with reference to FIG. 4, and it is not repeated here.

In some embodiments, the network device and the terminal may start to measure when the terminal requests access network, and the method may further include steps 280 and 290 before steps 210.
Optionally, 280: the terminal transmits request information to the network device.

The request information requests access network. Alternatively, the request information requests access a service, and the provision of the service is based on distance between the network device and the terminal.

Optionally, the request information may be carried in an access request message. For example, the access request message includes the request information and may further include at least one of the following: encryption information, and identity information of the terminal, where the encryption information may be used to encrypt the access request message and the identity information indicates the terminal requesting access network.

For example, the access request message may be: Encₖ{ID_{UE}∥Cmd_Req∥Nonce}∥MACₖ{ID_{UE}∥Cmd_Req∥Nonce}, where Encₖ represents encryption, ID_{UE} represents the identity of the terminal, Cmd_Req (command to request) represents the first request information.
Optionally, 290: the network device transmits acknowledgement information to the terminal.

The acknowledge information responds to the request information. The network device may accept the request from the terminal, and transmits the acknowledgement information to the terminal.

Optionally, the acknowledge information is carried in an acknowledgement response message which responds to the access request message. For example, the acknowledgement response message includes the first acknowledge information and may further include at least one of the following: encryption information, and identity information of the terminal.

For example, the acknowledgement response message may be: Encₖ{ID_{UE}∥Cmd_Ack∥Nonce}∥MACₖ{ID_{UE}∥Cmd_Req∥Nonce}, where the Cmd_Ack (command_acknowledgement) and the other parameters may be the same as those described in the access request message.

Optionally, if the network device determines the period of time T, and indicates the terminal to measure received signals over the period of time T. For example, the network device may send a measurement indication information to the terminal, where the measurement indication information indicates the terminal to measure the power of the received signals over the period of time T. Then the terminal may start to measure the power of the received signals after receiving the first acknowledgement information over the period of time T. The measurement indication information may be carried in the acknowledgement response message or carried in other messages. This is not limited in embodiments of this application.

In this application, a network device determines whether a terminal is allowed to access network after double verifications. A first verification is based on a first measurement result, which is measured by the network device. If the network device determines that the terminal is not rejected to access network, the network device would perform a second verification based on authentication information, which is obtained based on a second measurement by the terminal. Thereby, an illegal terminal uses high power to transmit signals to the network device, the network device measures received signals and gets wrong result in the first verification. Since the illegal could not obtain right authentication, the network device would reject the illegal terminal to access network in the second verification. Thus, the authentication method proposed in this application can improve the security of access network.

The authentication method has been described above, and the quantization processing and secure sketch processing mentioned in steps 241 and 242 above will be described in more detail below with reference to FIG. 3.

FIG. 3 is a schematic diagram of quantization processing and secure sketch processing on a terminal side.

The second measurement result includes signal strength of the second signals, which may be represented as set X={x₁, x₂, . . . , x_{N}}, and can be obtained by step 220 referring to FIG. 2.
301: the terminal performs a quantization processing on the second measurement result.

Optionally, the terminal may perform noise reduction processing on N signal strength values. For example, the N signal strength values are passed through a low-pass filter to reduce noise components, which are due to path fading. It should be understood that there may be only small-scale fading variations in the N signal strength values after passing through the low-pass filter.

Optionally, the terminal encodes the signal strength values after noise reduction processing, and then an encoded quantized values set A={a₁, a₂, . . . } is obtained. For example, the signal strength values after noise reduction processing are converted to bits by multi-bit quantization. The terminal may determine the number of bits N to encode the signal strength values, such as K is calculated as N=log₂(range_of_values), where the range_of_values is obtained by evaluating the signal strength values. Then the sample bits which are converted by multi-bit quantization may be divided into M=2^{N} quantization levels, e.g. M=4 (four) level quantization, each signal strength value is encoded as 2-bit based on the level in which it lies. Optionally, the terminal may use Gray coding so that each of the encoded signal strength values differ by only 1-bit in order to minimise discrepancies. This is not limited in embodiments of this application.
302: the terminal generates the auxiliary information, which may be used to assist the network device to perform a recovery processing. The auxiliary information may be presented as a padding set P={p₁, p₂, . . . }.

Optionally, the terminal may generate the P based on a quantization mode. For example, if the terminal uses 4-level quantization, then A will be encoded as 2 bits. And if (7, 4) Hamming encoding is used, then the terminal encodes the A as 7 bits, and the A is appended with 5 more bits. This 5 bits are randomly chosen by the terminal and communicated with the network device. The padding set P is adjusted as per the Hamming encoding and number of bits used to encode each signal strength.

It should be noted that the terminal needs to send the auxiliary information to the network device as described in step 260 referring to FIG. 2. Therefore, the network device may use the auxiliary information (e.g. the padding set P) for a recovery processing as described in FIG. 4 below.
303: the terminal connects the encoded quantized values set A and the padding set P to obtain W=A∥P.
304: the terminal randomly generates set R={r₁, r₂, . . . }.
305: the terminal calculates C=HE(R), where HE is the Hamming encoding.
306: the terminal calculates S=W⊕C, where ⊕ is the xor operation.

Therefore, the authentication information is obtained.

The quantization processing and secure sketch processing have been described above, and the quantization processing on the first measurement result mentioned in 271 referring to FIG. 2 and the recovery processing on the authentication information mentioned in 272 referring to FIG. 2 will be described in more detail below with reference to FIG. 4.

FIG. 4 is a schematic diagram of a quantization processing and a recovery processing on a network device side.

The first measurement result includes signal strength of the first signals, which may be represented as set Y={y₁, y₂, . . . , y_{M}}, and can be obtained by step 210 referring to FIG. 2. Obtaining of auxiliary information can refer to step 260 in FIG. 2. Obtaining of authentication information can refer to step 270 in FIG. 2. Moreover, the auxiliary information is the same as P in 302 referring to FIG. 3 and the authentication information is the same as S in 306 referring to FIG. 3.
401: the network device performs a quantization processing on the first measurement result to obtain an encoded quantized values set B={b₁, b₂, . . . }.

The network device performs quantization in a similar way to the terminal quantization, which is described in 301 referring to FIG. 3. It will not be repeated here.
402: the network device connects the encoded quantized values set B and the padding set P to obtain W′=B∥P.
403: the network device calculates D′=W′⊕S, where ⊕ is the xor operation and D′ may be same as C as described in FIG. 3.
404: the network device decodes D′ to obtain D, such as D=HD (D′), where HD is the hamming decoding.
405: the network device calculates W_recovery=S⊕D.

It should be noted that the output W_recovery can be considered as a successful recovery by the network device only if dis(W_recovery, W′)≤t. For example, for a hamming encoding (7, 4), the distance between W and W′ must be lesser than or equal to 1. If W_recovery˜W′.

According to the description of the above method, it can be seen that a network device determines whether a terminal is allowed to access network after double verifications, which can improve the security of access network.

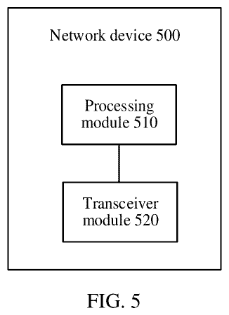

The authentication method according to the embodiments of this application is described in detail above with reference to FIGS. 2-4, and the terminal and the network device according to the embodiments of this application are described in detail below with reference to FIGS. 5-9.

FIG. 5 is a schematic block diagram of a network device 500 according to an embodiment of this application. As shown in FIG. 5, the network device 500 includes:
a processing module 510, configured to measure at least one first signal from a terminal to obtain a first measurement result, wherein the first measurement result is used for determining the distance between the terminal and the network device;
where the processing module 510 is further configured to determine that the terminal is not rejected to access network based on the first measurement result; and
a transceiver module 520, configured to transmit at least one second signal to the terminal;
where the transceiver module 520 is further configured to receive authentication information from the terminal, where the authentication information is obtained based on a second measurement result of the at least one second signal; and
the processing module 510 is further configured to determine whether the terminal is allowed to access network based on the authentication information.

Optionally, the processing module 510 is further configured to perform a recovery processing on the authentication information successfully based on the first measurement result, so that the terminal is allowed to access network, wherein the recovery processing corresponds to the secure sketch processing.

Optionally, the processing module 510 is further configured to perform a recovery processing on the authentication information unsuccessfully based on the first measurement result, so that the terminal is not allowed to access network, wherein the recovery processing corresponds to the secure sketch processing.

Optionally, the transceiver module 520 is further configured to receive request information from the terminal, where the request information requests access network; and the transceiver module 520 is further configured to transmit acknowledgement information to the terminal, wherein the acknowledgement information indicates the terminal transmitting the at least one first signal and measuring the at least one second signal.

Optionally, the processing module 510 is further configured to perform a quantization processing on the first measurement result, and performing the recovery processing on the authentication information based on the quantized first measurement result.

Optionally, the at least one first signal is measured over a period of time, and the at least one second signal is transmitted over the period of time.

Optionally, the first measurement result comprises signal strength of the at least one first signal, and the second measurement result comprises signal strength of at least one second signal.

Therefore, a network device determines whether a terminal is allowed to access network after double verifications. A first verification is based on a first measurement result, which is measured by the network device. If the network device determines that the terminal is not rejected to access network, the network device would perform a second verification based on the authentication information, which is obtained based on a second measurement by the terminal. Thereby, an illegal terminal uses high power to transmit signals to the network device, the network device measures received signals and gets wrong result in the first verification. Since the illegal could not obtain right authentication, the network device would reject the illegal terminal to access network in the second verification. Thus, the authentication method proposed in this application can improve the security of access network.

It should be understood that, the network device 500 in this embodiment of this application may correspond to the network device in the authentication method in the embodiments of this application, and the foregoing management operations and/or functions and other management operations and/or functions of modules of the network device 500 are intended to implement corresponding steps of the foregoing methods. For brevity, details are not described herein again.

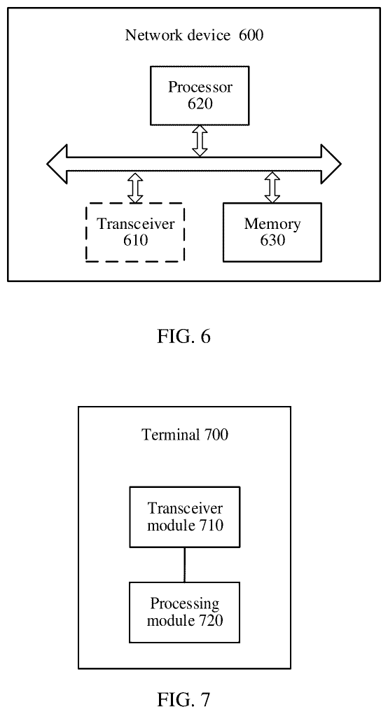

The transceiver module 520 in this embodiment of this application may be implemented by a transceiver, and the processing module 510 may be implemented by a processor. As shown in FIG. 6, a network device 600 may include a transceiver 610, a processor 620, and a memory 630. The memory 630 may be configured to store indication information, or may be configured to store code, an instruction, and the like that is to be executed by the processor 620.

FIG. 7 is a schematic block diagram of a terminal 700 according to an embodiment of this application. As shown in FIG. 7, the terminal 700 includes:
a transceiver module 710, configured to transmit at least one first signal to a network device, wherein the at least one first signal is used for determining the distance between the terminal and the network device; and
a processing module 720, configured to measure at least one second signal from the network device to obtain a second measurement result;
where the processing module 720 is further configured to obtain authentication information based on the second measurement result, wherein the authentication information is used for determining whether the terminal is allowed to access network; and
where the transceiver module 710 is further configured to transmit the authentication information to the network device.

Optionally, the processing module 720 is further configured to perform a secure sketch processing on the second measurement result to obtain the authentication information.

Optionally, the transceiver module 710 is further configured to transmit request information to the network device, wherein the request information requests access network; and the transceiver module 710 is further configured to receive acknowledge information from the network device, wherein the acknowledgement information indicates the terminal transmitting the at least one first signal and measuring the at least one second signal.

Optionally, the processing module 720 is further configured to perform a quantization processing on the second measurement result, and performing the secure sketch processing on the quantized second measurement result to obtain the authentication information.

Optionally, the at least one second signal is measured over a period of time, and the at least one first signal is transmitted over the period of time.

Optionally, the first measurement result comprises signal strength of the at least one first signal, and the second measurement result comprises signal strength of at least one second signal.

It should be understood that, the terminal 700 in this embodiment of this application may correspond to the terminal in the authentication method in the embodiments of this application, and the foregoing management operations and/or functions and other management operations and/or functions of modules of the terminal 700 are intended to implement corresponding steps of the foregoing methods. For brevity, details are not described herein again.

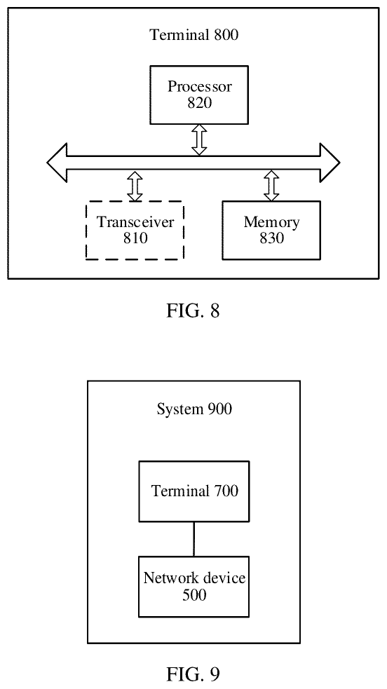

The transceiver module 710 in this embodiment of this application may be implemented by a transceiver, and the processing module 720 may be implemented by a processor. As shown in FIG. 8, a terminal 800 may include a transceiver 810, a processor 820, and a memory 830. The memory 830 may be configured to store indication information, or may be configured to store code, an instruction, and the like that is to be executed by the processor 820.

It should be understood that the processor 620 or the processor 820 may be an integrated circuit chip and have a signal processing capability. In an implementation process, steps in the foregoing method embodiments can be implemented by using a hardware integrated logical circuit in the processor, or by using instructions in a form of software. The processing module 610 may be a general purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a discrete gate or a transistor logic device, or a discrete hardware component. All methods, steps, and logical block diagrams disclosed in this embodiment of the present invention may be implemented or performed. The general purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory 630 or the memory 830 in the embodiments of the present invention may be a volatile memory or a non-volatile memory, or may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). It should be noted that the storage of the system and the method described in this specification aims to include, but is not limited to, these and any other proper storage.

An embodiment of this application further provides a system. As shown in FIG. 9, the system 900 includes:
the network device 500 according to the embodiments of this application and the terminal 700 according to the embodiments of this application.

An embodiment of this application further provides a computer storage medium, and the computer storage medium may store a program instruction for executing any of the foregoing methods.

Optionally, the storage medium may be specifically the memory 630 or 830.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of the embodiments.

In addition, function units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An authentication method, applicable for a network device, comprising:
measuring at least one first signal from a terminal to obtain a first measurement result, wherein the first measurement result is used for determining a distance between the terminal and the network device;
determining that the terminal is not rejected to access network based on the first measurement result;
transmitting at least one second signal to the terminal;
receiving authentication information from the terminal, wherein the authentication information is obtained based on a second measurement result of the at least one second signal; and
determining whether the terminal is allowed to access network based on the authentication information.

2. The method according to claim 1, wherein the authentication information is obtained by performing a secure sketch processing on the second measurement result, and determining whether the terminal is allowed to access network based on the authentication information comprises:
a recovery processing is performed on the authentication information successfully based on the first measurement result, the terminal is allowed to access network, wherein the recovery processing corresponds to the secure sketch processing; or
the recovery processing is performed on the authentication information unsuccessfully based on the first measurement result, the terminal is not allowed to access network.

3. The method according to claim 1, wherein the method further comprises:
receiving request information from the terminal, wherein the request information requests access network; and
transmitting acknowledgement information to the terminal, wherein the acknowledgement information indicates the terminal transmitting the at least one first signal and measuring the at least one second signal.

4. The method according to claim 2, wherein performing the recovery processing on the authentication information based on the first measurement result comprises:
performing a quantization processing on the first measurement result, and performing the recovery processing on the authentication information based on the quantized first measurement result.

5. The method according to claim 1, wherein the at least one first signal is measured over a period of time, and the at least one second signal is transmitted over the period of time.

6. The method according to claim 1, wherein the first measurement result comprises signal strength of the at least one first signal, and the second measurement result comprises signal strength of at least one second signal.

7. An authentication method, applicable for a terminal, comprising:
transmitting at least one first signal to a network device, wherein the at least one first signal is used for determining the distance between the terminal and the network device;
measuring at least one second signal from the network device to obtain a second measurement result;
obtaining authentication information based on the second measurement result, wherein the authentication information is used for determining whether the terminal is allowed to access network; and
transmitting the authentication information to the network device.

8. The method according to claim 7, wherein obtaining the authentication information based on the second measurement result comprises:
performing a secure sketch processing on the second measurement result to obtain the authentication information.

9. The method according to claim 7, wherein the method further comprises:
transmitting request information to the network device, wherein the request information requests access network; and
receiving acknowledge information from the network device, wherein the acknowledgement information indicates the terminal transmitting the at least one first signal and measuring the at least one second signal.

10. The method according to claim 8, wherein the performing the secure sketch processing on the second measurement result to obtain the authentication information comprises:
performing a quantization processing on the second measurement result, and performing the secure sketch processing on the quantized second measurement result to obtain the authentication information.

11. The method according to claim 9, wherein the performing the secure sketch processing on the second measurement result to obtain the authentication information comprises:
performing a quantization processing on the second measurement result, and performing the secure sketch processing on the quantized second measurement result to obtain the authentication information.

12. The method according to claim 7, wherein the at least one second signal is measured over a period of time, and the at least one first signal is transmitted over the period of time.

13. The method according to claim 7, wherein the first measurement result comprises signal strength of the at least one first signal, and the second measurement result comprises signal strength of at least one second signal.

14. A communication apparatus, comprising: at least one processor coupled to at least one memory storing a computer program including instructions that, when executed by the processor, cause the communication apparatus to perform:
transmitting at least one first signal to a network device, wherein the at least one first signal is used for determining the distance between the communication apparatus and the network device;
measuring at least one second signal from the network device to obtain a second measurement result;
obtaining authentication information based on the second measurement result, wherein the authentication information is used for determining whether the communication apparatus is allowed to access network; and
transmitting the authentication information to the network device.

15. The communication apparatus according to claim 14, wherein the obtaining the authentication information based on the second measurement result comprises:
performing a secure sketch processing on the second measurement result to obtain the authentication information.

16. The communication apparatus according to claim 14, wherein when the instructions are executed by the processor, further cause the communication apparatus to perform:
transmitting request information to the network device, wherein the request information requests access network; and
receiving acknowledge information from the network device, wherein the acknowledgement information indicates the communication apparatus transmitting the at least one first signal and measuring the at least one second signal.

17. The communication apparatus according to claim 15, wherein the performing the secure sketch processing on the second measurement result to obtain the authentication information comprises:
performing a quantization processing on the second measurement result, and performing the secure sketch processing on the quantized second measurement result to obtain the authentication information.

18. The communication apparatus according to claim 16, wherein the performing the secure sketch processing on the second measurement result to obtain the authentication information comprises:
performing a quantization processing on the second measurement result, and performing the secure sketch processing on the quantized second measurement result to obtain the authentication information.

19. The communication apparatus according to claim 14, wherein the at least one second signal is measured over a period of time, and the at least one first signal is transmitted over the period of time.

20. The communication apparatus according to claim 14, wherein the first measurement result comprises signal strength of the at least one first signal, and the second measurement result comprises signal strength of at least one second signal.
